(19) United States
(12) Patent Application Publication
(10) Pub. No.: US 2013/0124167 A1
(43) Pub. Date: May 16, 2013

(54) METHOD FOR USING MULTI-GAUSSIAN MAXIMUM-LIKELIHOOD CLUSTERING AND LIMITED CORE POROSITY DATA IN A CLOUD TRANSFORM GEOSTATISTICAL METHOD

(71) Applicant: Julian Thorne, Orange, CA (US)

(72) Inventor: Julian Thorne, Orange, CA (US)

(73) Assignee: Chevron U.S.A. Inc., San Ramon, CA (US)

(21) Appl. No.: 13/677,401

(22) Filed: Nov. 15, 2012

Related U.S. Application Data
(60) Provisional application No. 61/560,233, filed on Nov. 15, 2011.

(51) Int. Cl. G06F 17/18

(52) U.S. Cl. CPC G06F 17/18
USPC 703/2

(57) ABSTRACT

A method of modeling porosity and permeability in a subsurface region includes modeling a sparse data set as a mixture of Gaussian distributions, each with a cluster center in permeability-porosity space using permeability-porosity covariance. A number and location of cluster centers as well as covariances and probabilities of each cluster are derived using an interative maximum-likelihood algorithm.

This Application is based upon and claims the benefit of U.S. Provisional Application 61/560,233 filed Nov. 15, 2011, the entire contents of which are incorporated herein by reference.

### FIELD OF THE INVENTION

The present invention relates generally to geostatistical modeling and more particularly to geostatistical modeling using clustering techniques.

### BACKGROUND

Geostatistical modeling of permeability may utilize geostatistical methods that are based on porosity and permeability data, and particularly the joint distribution of porosity vs. permeability. However, frequently the data are sparse and therefore the joint distribution is underdetermined. Where data are sparse, the distribution will not be smooth, and a resulting model will exhibit sawtooth fluctuations. Smoothing algorithms have been suggested in order to reduce the problem of sawtooth fluctuations, but where the smoothing algorithm is not carefully selected, the statistics of the underlying data may not be reproduced in the smoothed data, or other constraints may be violated, as described for example by Xu and Journel, “Histogram and Scattergram Smoothing Using Convex Quadratic Programming,” Mathematical Geology, vol. 27, No. 1, 1995, 83-103.

### SUMMARY

An aspect of an embodiment of the present invention includes a method for modeling a pair of related properties of a subsurface region including obtaining data representative of the properties of the subsurface region, applying weights to the data, selecting parameters for the modeling, the parameters including a maximum number of clusters, a random seed and a number of points in an output cloud, solving for a number and location of cluster centers, covariances and probabilities for each cluster by use of a maximum-likelihood algorithm to produce a maximum-likelihood model, and sampling from the maximum-likelihood model with a probability given by a joint multi-variate Gaussian distribution.

An aspect of an embodiment of the invention further includes modeling the porosity axis as one of a variable density and a uniform density, the selected density depending on a binning method to be applied to the cloud transformation.

An aspect of an embodiment may include a system for performing any of the foregoing methods.

An aspect of an embodiment of the present invention includes a system including a data storage device and a processor, the processor being configured to perform the foregoing method.

Aspects of embodiments of the present invention include computer readable media encoded with computer executable instructions for performing any of the foregoing methods and/or for controlling any of the foregoing systems.

### DESCRIPTION OF THE DRAWINGS

Other features described herein will be more readily apparent to those skilled in the art when reading the following detailed description in connection with the accompanying drawings, wherein:

FIG. 1 shows an exemplary method in accordance with the present invention;

FIGS. 2a and 2b are a pair of porosity-permeability plots having a logarithmic vertical scale, wherein FIG. 1a represents measured core data, and FIG. 1b represents smoothed data derived from the data of FIG. 1a in accordance with an embodiment of the present invention;

FIGS. 3a and 3b are a pair of porosity-permeability plots having a logarithmic vertical scale, wherein FIG. 3a represents measured core data, and FIG. 3b represents smoothed data derived from the data of FIG. 3a in accordance with an embodiment of the present invention;

FIGS. 4a and 4b are a pair of porosity-permeability plots having a logarithmic vertical scale, wherein FIG. 4a represents measured core data, and FIG. 4b represents smoothed data derived from the data of FIG. 4a in accordance with an embodiment of the present invention;

FIGS. 5a and 5b are a pair of porosity-NPHI plots, wherein FIG. 5a represents measured core data, and FIG. 5b represents smoothed data derived from the data of FIG. 5a in accordance with an embodiment of the present invention;

FIGS. 6a and 6b are a pair of porosity-permeability plots having a logarithmic vertical scale, wherein FIG. 6a represents measured core data, and FIG. 6b represents smoothed data derived from the data of FIG. 6a in accordance with an embodiment of the present invention; and

FIGS. 7a and 7b are a pair of porosity permeability plots having a logarithmic vertical scale, wherein FIG. 7a represents measured core data, and FIG. 7b represents smoothed data derived from the data of FIG. 7a in accordance with an embodiment of the present invention.

### DETAILED DESCRIPTION

A method of modeling related properties of a subsurface region, for example porosity and permeability, includes modeling a sparse data set as a mixture of Gaussian distributions, each with a cluster center in permeability-porosity space using permeability-porosity covariance. A number and location of cluster centers as well as covariances and probabilities of each cluster are derived using an interative maximum-likelihood algorithm.

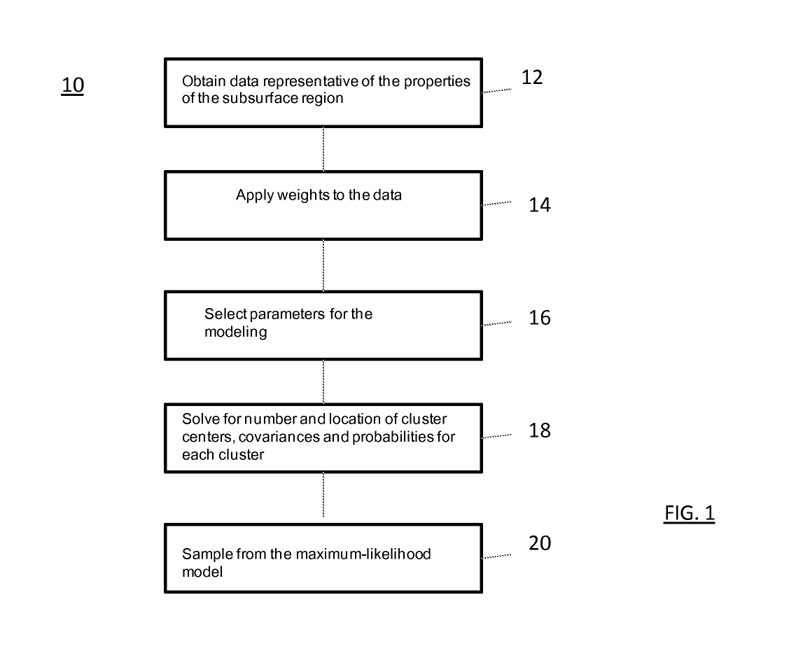

FIG. 1 shows a method 10 for modeling a pair of related properties of a subsurface region in accordance with and embodiment of the present invention. The method includes the step of obtaining data representative of the properties of the subsurface region, step 12, for example data representative of porosity and permeability, and applying weights to the data, step 14. The data can be further transformed, for example, to log (porosity) versus log (permeability), or porosity versus log (permeability) depending on user preferences. The method 10 further includes the steps of selecting parameters for the modeling, the parameters including a maximum number of clusters, a random seed and a number of points in an output cloud, step 16, solving for a number and location of cluster centers, covariances and probabilities for each cluster by use of a maximum-likelihood algorithm to produce a maximum-likelihood model, step 18, and sampling from the maximum-likelihood model with a probability given by a joint multi-variate Gaussian distribution, step 20.

In one embodiment, porosity-permeability points are randomly sampled from the maximum-likelihood model with a probability given by the joint multi-variate Gaussian distribution.

In another embodiment, a porosity axis is modeled as having a variable density. This approach may be useful in the case where a cloud transform simulation is to be applied in which a specified number of data points are to be contained in each bin. In another embodiment, a post-processing step may be applied to create a cloud having a uniform density along the porosity axis. This approach may be useful where the number of bins is to be specified and each bin is to be equally sized.

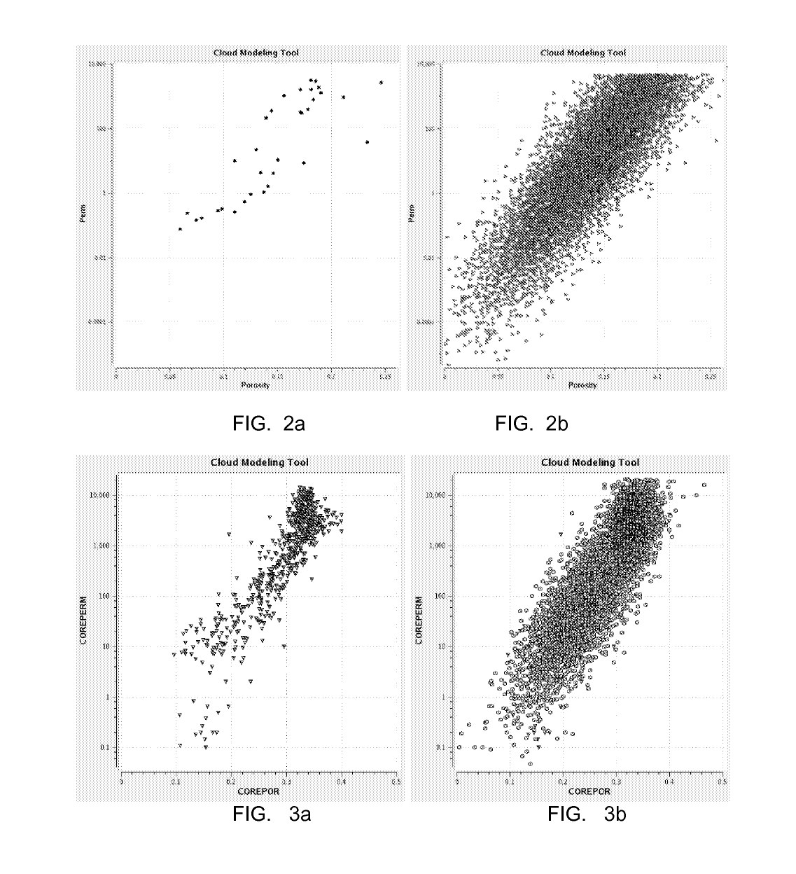

Six examples of transformed data in accordance with embodiments of the invention are illustrated in the paired FIGS. 2a-2b through 7a-7b. In each pair, the left hand side illustrates a sparse data set of permeability-porosity information for a particular field. As will be appreciated, such data is generally obtained from core sample measurements. Because coring, particularly at great depth, can be expensive, the data for a large field will in most cases be relatively sparse.

FIG. 2a shows an initial data set represented in a plot in which the permeability is log plotted while the porosity is plotted linearly. As will be appreciated, it may be useful to use a log-log plot where porosity has a larger variation, and it may be appropriate not to transform either porosity or permeability. In the case represented in FIG. 2a, permeability ranges from less than 1 to 10,000, so logarithmic representation is appropriate for that axis.

FIG. 2b illustrates an extrapolated conditional probability distribution for the data of FIG. 2a obtained by application of a method in accordance with an embodiment of the present invention. In particular, a number of elliptical sub-clouds is determined along with a random seed and number of points to be included in the output cloud. An iterative maximum-likelihood algorithm is applied to solve for a number and location of cluster centers as well as covariances and probabilities for each cluster. The joint multi-variant Gaussian distribution is used as a probability function for sampling from the maximum likelihood model. The output as shown in FIG. 2b is smoother than the original sparse data set, while retaining a statistically similar correlation between permeability and porosity to that of the original data of FIG. 2a.

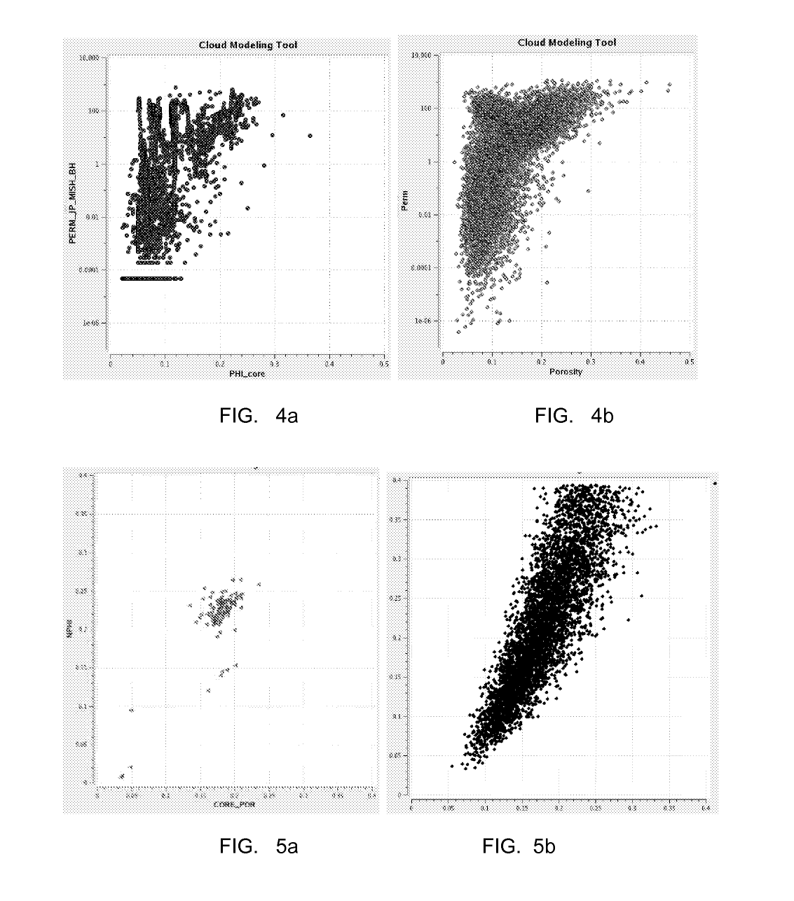

Similar results are illustrated in FIGS. 3a and 3b, and FIGS. 4a and 4b, based on different initial data sets from different fields.

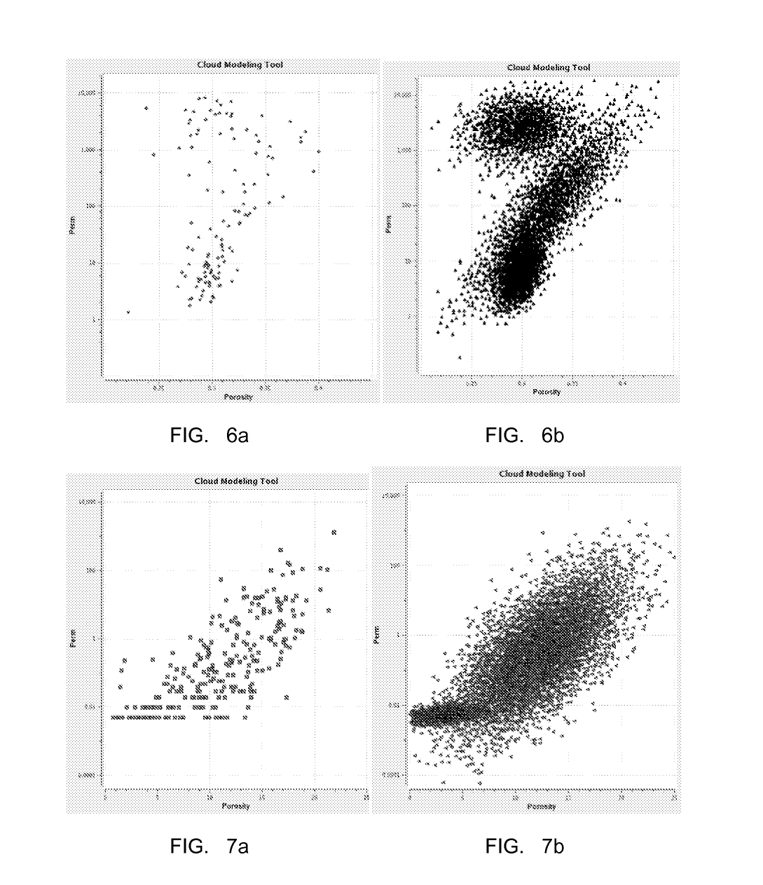

FIG. 5a uses neutron permeability (NPHI) rather than permeability data. Because the variation in NPHI data as measured for field four is relatively small (range between 0-0.4), it is not log transformed as was done in FIGS. 2a-2b through 4a-4b. The examples shown for fields 5 and 6 (FIGS. 6a, 6b and 7a, 7b) are similar to those of FIGS. 2a-2b through 4a-4b.

As will be appreciated, the method as described herein may be performed using a computing system having machine executable instructions stored on a tangible medium. The instructions are executable to perform each portion of the method, either autonomously, or with the assistance of input from an operator.

In an embodiment, a system for modeling a pair of related properties of a subsurface region includes a data storage device having machine readable data representative of the properties of the subsurface region, and a processor in communication with the data storage device. The processor is configured and arranged to: apply weights to the data; select parameters for the modeling, the parameters including a maximum number of clusters, a random seed and a number of points in an output cloud; solve for number and location of cluster centers, covariances and probabilities for each cluster by use of a maximum-likelihood algorithm to produce a maximum-likelihood model; and sample from the maximum-likelihood model with a probability given by a joint multi-variate Gaussian distribution.

In an embodiment, the system includes structures for allowing input and output of data, and a display that is configured and arranged to display the intermediate and/or final products of the process steps. A method in accordance with an embodiment may include an automated selection of a location for exploitation and/or exploratory drilling for hydrocarbon resources. Where the term processor is used, it should be understood to be applicable to multi-processor systems and/or distributed computing systems.

Those skilled in the art will appreciate that the disclosed embodiments described herein are by way of example only, and that numerous variations will exist. The invention is limited only by the claims, which encompass the embodiments described herein as well as variants apparent to those skilled in the art. In addition, it should be appreciated that structural features or method steps shown or described in any one embodiment herein can be used in other embodiments as well.

What is claimed is:

1. A method of modeling a pair of related properties of a subsurface region comprising:
obtaining data representative of the properties of the subsurface region;
applying weights to the data;
selecting parameters for the modeling, the parameters including a maximum number of clusters, a random seed and a number of points in an output cloud;
solving for a number and location of cluster centers, covariances and probabilities for each cluster by use of a maximum-likelihood algorithm to produce a maximum-likelihood model; and
sampling from the maximum-likelihood model with a probability given by a joint multi-variate Gaussian distribution.

2. A method as in claim 1, wherein prior to the solving, data relating to at least one of the properties is transformed to a lograrithmic representation thereof.

3. A method as in claim 1 or 2, wherein after the sampling, the model is post-processed to produce a uniform density along an axis of one of the properties.

4. A method as in any of claims 1-3, wherein the properties comprise porosity and permeability.

5. A system for modeling a pair of related properties of a subsurface region comprising:
a data storage device having machine readable data representative of the properties of the subsurface region; and
a processor in communication with the data storage device, the processor being configured and arranged to:
apply weights to the data;
select parameters for the modeling, the parameters including a maximum number of clusters, a random seed and a number of points in an output cloud;
solve for number and location of cluster centers, covariances and probabilities for each cluster by use of a maximum-likelihood algorithm to produce a maximum-likelihood model; and
sample from the maximum-likelihood model with a probability given by a joint multi-variate Gaussian distribution.

6. A system as in claim 5, further comprising, a display, configured and arranged to output a model generated by the processor.
